(19) United States
(12) Patent Application Publication
(10) Pub. No.: US 2026/0288165 A1
(43) Pub. Date: Sep. 24, 2026

(54) METHOD FOR COLLABORATIVE CONTROL OF MULTIPLE AGVS CO-TRANSPORTING HEAVY MATERIAL

(71) Applicant: Machinery Technology Development Co., Ltd, Beijing (CN)

(72) Inventors: Haotian XIE, Beijing (CN); Yang LIU, Beijing (CN); Yong AO, Beijing (CN); Zhaoqi KANG, Beijing (CN); Zhiheng DENG, Beijing (CN); Yangqing HE, Beijing (CN); Xianqiang LI, Beijing (CN); Jiaqing CAI, Beijing (CN); Chunping DAI, Beijing (CN); Xinwei LIU, Beijing (CN); Yuheng HU, Beijing (CN)

(73) Assignee: Machinery Technology Development Co., Ltd, Beijing (CN)

(21) Appl. No.: 19/448,238

(22) Filed: Jan. 14, 2026

(30) Foreign Application Priority Data
Mar. 21, 2025 (CN) 202510338043.9

(51) Int. Cl. G05D 1/69; G05D 1/667; G05D 105/28

(52) U.S. Cl. CPC G05D 1/69; G05D 1/667; G05D 2105/28

(57) ABSTRACT

Provided is a method for collaborative control of multiple AGVs co-transporting a heavy material, including: inputting a high-dimensional environmental description vector, as a model condition, into an improved conditional diffusion model that is constructed by introducing a collaboration constraint feature channel in the reverse denoising phase of a conventional conditional diffusion model, to obtain a preliminary solution; correcting the preliminary solution using a manifold theory and high-dimensional differential geometric constraints; and then, according to the corrected solution, employing dynamic environmental perception and collaboration state prediction, online feedback and local path adjustment mechanisms, as well as a multi-heavy-duty-AGV synchronous control strategy during controlled operation to ensure the collaborative control of the multiple AGVs. The method of the present disclosure enhances the feasibility and collaboration of generated results, and achieves optimization of a speed, an acceleration, and a steering angle of each AGV using a high-dimensional differential geometric dynamic control method.

### CROSS-REFERENCE TO RELATED APPLICATIONS

This application claims priority of Chinese Patent Applicant No. 202510338043.9, filed on Mar. 21, 2025, entitled as “Method for Collaborative Control of Multiple AGVs Co-Transporting Heavy Material,” the entire disclosure of which is incorporated herein by reference for all purposes.

### TECHNICAL FIELD

The present disclosure relates to the technical field of automated logistics, and in particular to a method for collaborative control of multiple AGVs co-transporting a heavy material.

### BACKGROUND

Conventional single-AGV transport methods rely on automated guided vehicles (AGVs) to transport materials along fixed paths. The single-AGV transport methods usually involve simple path planning and control, but are only suitable for transporting small-sized and lightweight materials. In modern manufacturing and logistics scenarios, transporting large-sized and heavy materials imposes stricter requirements on the automation and flexibility of production line than in conventional scenarios. Conventional transport methods usually rely on single-AGV transport along fixed paths or manual operations, which are inefficient and struggle to adapt to complex and variable production environments. How to efficiently and safely transport large-sized and heavy materials in a limited space has become a pressing challenge in the process of intelligent upgrading of production lines.

Therefore, in the related art, multi-AGV co-transport methods have been applied in some heavy-duty scenarios. By sharing the load and optimizing the path, the multi-AGV co-transport methods can improve efficiency and stability of transport, enabling multiple AGVs to work jointly to complete transport tasks. For multi-AGV collaborative systems, existing path planning technologies usually rely on static algorithms to calculate a moving path of each AGV, ensuring that no conflicts occur among AGVs and material co-transport is implemented. To cope with dynamic environmental changes (such as obstacles), the related art introduces dynamic path adjustment and obstacle avoidance techniques, which are capable of altering paths in real time to bypass dynamic obstacles and ensure smooth execution of transport tasks. In multi-AGV co-transporting, the related art adopts a synchronous control strategy to ensure consistency in the speed, position, and direction of movement among AGVs. Synchronous control is usually implemented through centralized or distributed control strategies to maintain transport stability. Some existing systems further introduce error detection and correction mechanisms, leveraging sensors and feedback systems to monitor AGV deviations and perform error correction, thereby maintaining accuracy and stability of transport.

Heavy-duty AGVs, due to their high flexibility and automation, are increasingly being introduced into scenarios involving the transport of large-sized and heavy materials. Compared with conventional single-AGV transporting, multi-AGV collaborative operations offer some advantages in heavy-duty scenarios. They can improve transport efficiency and system stability by sharing weight, optimizing path planning, and collaborating movement. However, due to the particularities of large-sized materials, multi-AGV co-transport still faces the following challenges in practical applications:

Complexity of path planning: To transport large-sized materials, multiple AGVs must collaborate to carry and transport the materials due to the large volume and heavy weight of the materials, making it impossible for a single AGV to complete path planning independently. Conventional static path planning algorithms are difficult to adapt to multi-AGV path planning in highly dynamic and complex transport scenarios, which require considering constraints such as material dimensionss, limited transport spaces, and potential obstacles in the dynamic environment.

Synchronization and precision of multi-AGV collaboration: When transporting large-sized materials, synchronization and collaboration among AGVs are critical. Deviations in AGV speed, position, or direction may lead to unstable material transport or even safety accidents. Furthermore, transporting large-sized materials requires AGVs to achieve a high-precision synchronous motion in the space, which places strict demands on control and collaboration among AGVs.

Real-time adjustment capability in dynamic environments: Large-sized and heavy materials usually need to be flexibly transported between production lines. Dynamic changes in the production environment (such as obstacles, road congestion, or temporary scheduling changes) require real-time responses during transport. When a multi-AGV system cannot quickly adjust the path and motion strategy according to real-time environmental changes, transport tasks may fail, or transport efficiency may significantly decline.

Error accumulation and reliability of feedback: For multi-AGV collaboration, deviations in position or path planning may arise due to sensor errors, communication delays, and other factors. Especially for large-sized materials, minor errors can be amplified, greatly affecting transport stability. Therefore, establishing a reliable error correction and feedback mechanism during transport is critical to ensuring transport stability and accuracy.

In summary, it has become urgent for enterprises in the production process to design a collaborative optimization and control strategy capable of generating reliable and collaborative path planning results for joint transport of multiple heavy-duty AGVs, and capable of ensuring synchronization among AGVs and maintaining a dynamic balance of load distribution throughout the motion of AGVs.

### SUMMARY

In view of this, an objective of the present disclosure is to provide a method for collaborative control of multiple AGVs co-transporting a heavy material, so as to solve the problem that it is difficult for an optimization or planning-based static method in the related art to cope with collaboration constraints in path planning among multiple AGVs in highly dynamic and highly complex transport scenarios under actual dynamic conditions.

To achieve the above objective, the method of the present disclosure enhances feasibility and collaboration of generated results by proposing an improved conditional diffusion model, introducing a collaboration constraint feature channel, and embedding geometric constraints, load limits, and aisle width limits. Specifically, the method includes:
1) inputting a high-dimensional environmental description vector into an improved conditional diffusion model as a model condition, to obtain a preliminary solution including an initial path and action sequence of the multiple AGVs to collaboratively perform a transport task, where the high-dimensional environmental description vector integrates kinematic feature information of the multiple AGVs to perform the transport task, real-time feasible region information of the multiple AGVs and a heavy material that the multiple AGVs co-transport, as well as real-time environmental information and real-time load information of the multiple AGVs collected by sensors; where
the improved conditional diffusion model is constructed by adding a geometric collision penalty term, an overload penalty term, and a factory aisle constraint penalty term for the heavy material in a reverse prediction equation in a reverse denoising phase of a conventional conditional diffusion model;
2) providing an overall continuous description for the initial path and action sequence using a manifold theory, correcting the obtained overall continuous description result to obtain correction values for a speed, an acceleration, and a steering angle of each AGV when constraint conditions are satisfied in a manifold space, and determining motion commands for each AGV according to the correction values to achieve collaborative motion control on the multiple AGVs; where
the constraint conditions refer to the satisfaction of a defined coupled motion constraint function for a force balance between the multiple AGVs and the heavy material, and the satisfaction of a defined high-dimensional differential geometric constraint mapping including a plurality of constraints on an AGV speed balance, a load distribution balance, and a stable material pose; and
3) in the collaborative motion control on the multiple AGVs, performing a short-term prediction on a future state according to real-time detection results from environmental sensors, and assessing a safety risk during operation of the multiple AGVs according to the short-term prediction result, implementing different adjustment strategies according to different safety risk assessment results to ensure the operational safety of the multiple AGVs; where
a multi-heavy-duty-AGV synchronous control law is designed based on a coupled dynamic equation, and a dynamic balance of load distribution is achieved through real-time allocation of AGV outputs.

The method of the present disclosure has at least the following beneficial effects: The high-dimensional environmental description vector in the method of the present disclosure not only includes real-time environmental information but also fuses AGV dynamic features to ensure comprehensive integration of dynamic sensing information. Moreover, this vector is capable of characterizing the co-transport state of the multiple heavy-duty AGVs and the large-sized and heavy material, external environmental disturbances, and geometric feasible region constraints, and of dynamically reflecting the co-transport state of the multiple AGVs and the large-sized and heavy material. Moreover, in the present disclosure, by introducing the collaboration constraint feature channel into the reverse denoising phase of the conventional conditional diffusion model, and embedding geometric constraints, load limits, and aisle width limits, the feasibility and collaboration of the generated results are significantly enhanced. A preliminary solution obtained based on this improved conditional diffusion model already has basic feasibility and global consistency, thereby laying a foundation for the subsequent refined control and correction of multi-AGV co-transport. In the method of the present disclosure, after obtaining the preliminary solution, the AGV speed, the acceleration, and the steering angle are optimized according to the manifold theory and the high-dimensional differential geometric constraint mapping to ensure dynamic consistency in the multi-AGV synchronous motion. Upon obtaining the corrected motion control commands, the multiple AGVs are controlled according to the commands, the motion state of the AGVs and the environmental conditions where the AGV are located are detected in real time during the control, and different strategies are formulated according to the different detection results to ensure both operational safety and operational efficiency of the AGVs.

In an embodiment, in the step 1), the real-time feasible region information includes a load limit, material dimensions, and an overall feasible region of the multiple AGVs and the heavy material; and when a load of the multiple AGVs and the material dimensions are within the feasible region, co-transporting the heavy material is implementable under the current geometric and load constraints.

In the present disclosure, through a geometric constraint relationship, it is ensured that the subsequently constructed environmental description model is capable of accurately characterizing the feasibility of synchronous transport between the large-sized and heavy material and the multiple AGVs.

In an embodiment, in the step 1), the reverse prediction equation in the reverse denoising phase of the improved conditional diffusion model is expressed as:

$${X}^{k - 1} = {f}_{θ} ( {X}^{k} , E ( t ) ) - λ {∇}_{{X}^{k}} {Ω}_{large} ( {X}^{k} , E ( t ) ) , k = K , K - 1 , … , 1 ; and$$

$${Ω}_{large} ( {X}^{k} , E ( t ) ) = {w}_{1} {Φ}_{collide} ( {X}^{k} , E ( t ) ) + {w}_{2} {Φ}_{overload} ( {X}^{k} , E ( t ) ) + {w}_{3} {Φ}_{narrow} ( {X}^{k} , E ( t ) ) ;$$

where f_{θ}(·) denotes a function in the conventional diffusion model for prediction according to a current state and conditional input, Ω_{large} (X^{k}, E(t)) denotes a penalty function for large-sized material features, λ denotes a hyperparameter used to balance a basic denoising objective of the model and a suppression intensity of a large-sized material collaboration constraint feature channel, w₁, w₂, w₃ denote weight coefficients for the three penalty terms, respectively, and Φ_{collide}, Φ_{overload}, Φ_{narrow} correspond to constraint functions for collision detection, load verification, and aisle width limit verification, respectively.

In the method of the present disclosure, the penalty function for the large-sized material features is added to the reverse prediction equation in the reverse denoising phase of the conditional diffusion model, to reduce random perturbations that do not meet the requirements of large-sized material co-transport, and to ensure the feasibility and collaboration of the generated results in the generated preliminary solution, such that the obtained preliminary solution has basic feasibility and global consistency. The penalty function includes penalty terms for the constraint functions for collision detection, load verification, and aisle width limit verification.

In an embodiment, in the step 2), the process of correcting the obtained overall continuous description result includes: defining a constraint function for the coupled motion on a manifold, constructing a high-dimensional differential geometric constraint mapping for differential geometric control, dynamically correcting the preliminary solution according to a high-dimensional differential geometric method, and solving for motion correction values for each AGV when the constraint conditions are satisfied in the manifold space.

In an embodiment, in the step 2), the dynamically correcting the preliminary solution according to a high-dimensional differential geometric method is as follows: performing a projection correction in a negative gradient direction of the constraint function in the manifold space, to cancel out components that violate synchronous coordination.

In an embodiment, in the step 2), the constraint function for the coupled motion is: f(q(t), \dot{q}(t))=0, where q(t) denotes a time-varying curve of a generalized coordinate vector providing the overall continuous description for the initial path and action sequence, and \dot{q}(t) denotes a time derivative of generalized coordinates;
the high-dimensional differential geometric constraint mapping h(q(t)) is expressed as:

$$h ( q ( t ) ) = [ \begin{matrix}\begin{matrix}\begin{matrix}{h}_{1} ( q ( t ) ) \\ {h}_{2} ( q ( t ) )\end{matrix} \\ ⋮\end{matrix} \\ {h}_{p} ( q ( t ) )\end{matrix} ] ,$$

where hᵢ(q(t)) denotes a plurality of constraints on an AGV speed balance, a load distribution balance, and a stable material pose balance; and when h(q(t))=0 is satisfied in the manifold space, the coupled motion of the multiple AGVs and the heavy material is in an ideal synchronous balanced state; and
a formula for dynamically correcting the preliminary solution according to the high-dimensional differential geometric method is expressed as:

$${\dot{q}}_{corr} ( t ) = {\dot{q}}_{i n i t} ( t ) - η {J}^{†} ∇ h ( {q}_{i n i t} ( t ) ) ;$$

$${\ddot{q}}_{corr} ( t ) = {\ddot{q}}_{i n i t} ( t ) - κ {J}^{†} ∇ h ( {\dot{q}}_{corr} ( t ) ) ;$$

$${θ}_{i , corr} ( t ) = {θ}_{i , init} ( t ) - ζ ∇ h ( {q}_{corr} ( t ) )$$

where \dot{q}_{corr}(t), \ddot{q}_{corr}(t), and θ_{i,corr}(t) denote a corrected speed, a corrected acceleration, and a corrected steering angle for each AGV, respectively, \dot{q}ᵢₙᵢₜ(t) denotes a speed vector derived from the preliminary solution, and ∇h(qᵢₙᵢₜ (t)) denotes a gradient of the constraint function; and J^{†} denotes a generalized inverse matrix or projection matrix of a corresponding Jacobian matrix J, η denotes a step size factor, and κ and ζ denote adjustable coefficients used to allocate correction magnitudes for the acceleration and the steering angle.

The high-dimensional differential geometric dynamic control is employed in the method of the present disclosure to perform a multi-AGV synchronous motion correction. In the scenario of the multiple AGVs and material transport, a generalized coordinate vector is constructed according to the manifold theory to continuously describe the force and motion states of the multi-AGV collaboration. Coupled motion constraints and a dynamic mapping are used to optimize the speed, the acceleration, and the steering angle of the multiple AGVs, so as to ensure dynamic consistency in the multi-AGV synchronous motion.

In an embodiment, in the step 3), the environmental sensors are multi-source environmental sensors, and the real-time detection results from the environmental sensors are globally consistent dynamic environmental information generated by fusing the results of the multi-source environmental sensors through the temporal alignment and weighted fusion.

The method of the present disclosure comprehensively integrates data from the multi-source sensors, and through the temporal alignment and weighted fusion, temporal differences and data accuracy differences among different AGVs are processed to obtain the globally consistent real-time environmental information, so as to ensure the accuracy of the obtained real-time environmental information, and provide an accurate real-time environmental basis for the subsequent state prediction and disturbance anticipation.

In an embodiment, in the step 3), the performing a short-term prediction on a future state includes:
predicting disturbance sources such as obstacle movement, aisle congestion, and load imbalance in combination with the dynamic environmental information and the motion commands obtained in the step 2); and
measuring a deviation between an actual state and an ideal reference state of each AGV at the same moment in combination with the dynamic environmental information and the motion commands obtained in the step 2).

In an embodiment, in the step 3), the process of assessing a safety risk during operation of the multiple AGVs according to the short-term prediction result includes:
in response to determining that the prediction result of the disturbance sources falls within a safe range and the measured result of the deviation does not exceed a set threshold, determining a safety risk level as 0;
in response to determining that the prediction result of the disturbance sources reaches a warning level or the measured result of the deviation exceeds the set threshold, determining the safety risk level as 1; and
in response to determining that the prediction result of the disturbance sources reaches a critical level of severe obstruction or an emergency, determining the safety risk level as 2.

In an embodiment, in the step 3), the implementing different adjustment strategies according to different safety risk assessment results includes:
when the safety risk level is 0, requiring only routine online monitoring;
when the safety risk level is 1, triggering a moderate correction of a speed adjustment or a steering angle adjustment; and
when the safety risk level is 2, implementing immediately a more mandatory response strategy of local path replanning or forced stopping.

In the present disclosure, during the operation of the multiple AGVs, through real-time detection and by adding a disturbance assessment process into the prediction model, disturbance sources such as obstacles and load distribution imbalance are quantified, and risk indicators are outputted to enable real-time detection of a potential safety hazard during the operation of the AGVs. According to the magnitude of the risk level, no intervention is performed when there is no risk, a simple intervention and adjustment are implemented when a minor risk situation occurs, and a path replanning or controlled stopping strategy is employed when a significant safety risk exists. This approach ensures both the operational safety and operational efficiency of the AGVs.

### BRIEF DESCRIPTION OF DRAWINGS

FIG. 1 is a flowchart of a method for collaborative control of multiple AGVs co-transporting a heavy material according to the present disclosure.

FIG. 2 is a schematic flowchart of a process of generating a path and action sequence according to the present disclosure.

FIG. 3 is a flowchart of a multi-AGV synchronous motion correction using high-dimensional differential geometric dynamic control according to the present disclosure.

### DETAILED DESCRIPTION OF THE EMBODIMENTS

The technical solution of the present disclosure will be described clearly and completely below in conjunction with specific embodiments. However, those skilled in the art should understand that the embodiments described herein are only for illustrating the present disclosure and should not be construed as limiting the scope of the present disclosure. Based on the embodiments in the present disclosure, all other embodiments obtained by those of ordinary skill in the art without making creative efforts will fall within the protection scope of the present disclosure.

### Embodiment of a Method for Collaborative Control of Multiple AGVs Co-Transporting a Heavy Material

This embodiment provides a method for collaborative optimization of multiple heavy-duty AGVs to transport a large-sized and heavy material, based on a conditional diffusion model and high-dimensional differential geometric dynamic control, to achieve efficient and safe path planning, synchronous control, real-time dynamic adjustment, and error feedback mechanisms through collaborative optimization of multiple AGVs in a transport scenario of a large-sized and heavy material, and to meet the transport requirements in a complex and dynamic environment.

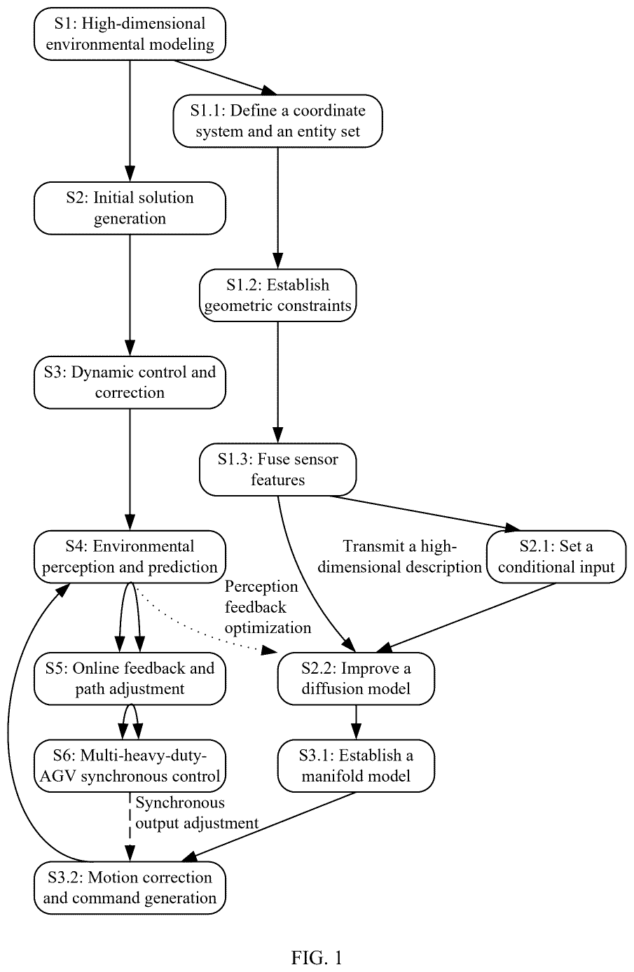

As shown in FIG. 1, the method for collaborative control of this embodiment includes the following steps:
S1. constructing a high-dimensional environmental description model for a multi-heavy-duty AGV co-transport scenario.
S11. establishing base coordinates and an entity set for a multi-heavy-duty AGV co-transport environment.

This step mainly aims to establish a basic reference system and key entities for the high-dimensional environmental description to provide a coordinate foundation and entity identification basis for the subsequent model construction.

Specifically, within an operating area of a factory, a global coordinate system is established, and information of all AGVs to participate in the transport and a heavy material to be transported is identified and recorded.
1. A fixed global coordinate system OXYZ is set; in the global coordinate system, O denotes an origin of coordinates, and X, Y and Z denote reference axes of the global coordinate system in plane and vertical directions, respectively.
2. {AGVᵢ} is defined to denote a coordinate transformation matrix Tᵢ corresponding to the i^{th} AGV, and {M} is defined to denote a primary geometric center and a pose reference coordinate Tₘ of the large-sized and heavy material.
3. A maximum load capacity Cᵢ of each AGV, an overall dimension Dₘ of the heavy material, and a pre-designed factory layout parameter L are collected, and stored in an initial environmental entity set [symbol] ={AGV₁, AGV₂, . . . , AGVₙ, M}.

Specifically, through the global coordinate system and the entity set, relative positions and poses between different AGVs and the heavy material may be uniformly calculated in the subsequent steps, to prevent mutual interference from a plurality of coordinate definitions.
S12. establishing a geometric constraint relationship between the large-sized and heavy material and multi-AGV collaboration.

This step mainly aims to, based on the above base coordinate system and entity set, consider dimensional boundaries of the large-sized and heavy material, load limits, and geometric collaboration constraints among the multiple AGVs, to construct a geometric foundation for the high-dimensional environmental description.

Specifically, a unified geometric description is provided for movement boundaries of each AGV and outline boundaries of the heavy material to form a collaboration relationship constraint function, and a geometric representation of an environmental feasible space is defined on this basis.
1. Ωᵢ(t)⊆ [symbol] ³ is defined to denote a geometric region occupied by the i^{th} AGV at a moment t, and Ωₘ(t)⊆ [symbol] ³ is defined to denote a geometric range of the large-sized and heavy material at a moment t.
2. An overall feasible region for the multiple AGVs and the heavy material is defined as [symbol] (t):

$$ℱ ( t ) = {⋂}_{i = 1}^{n} ( {Θ}_{i} ( {Ω}_{i} ( t ) ) ) {∩Θ}_{m} ( {Ω}_{m} ( t ) ) ;$$

where Θᵢ(·) denotes a coordinate transformation operation of the i^{th} AGV relative to the global coordinate system OXYZ, and Θₘ(·) denotes a coordinate transformation operation of the heavy material relative to the global coordinate system.
3. A load capacity limit Cᵢ and material dimensions Dₘ are incorporated into the collaboration constraint, and a constraint function φ(·) is defined as:

$$ϕ ( {C}_{i} , {D}_{m} , ℱ ( t ) ) = \{ \begin{matrix}1 , & when the load of all AGVs and the material dimensions fall within the feasible region \\ 0 , & otherwise\end{matrix}$$

when φ=1, it is indicated that the large-sized and heavy material may be co-transported under the current geometric and load constraints; and
when φ=0, it is indicated that the co-transport requirements cannot be met.

Through the geometric constraint relationship, it is ensured that the subsequently constructed environmental description model is capable of accurately characterizing the feasibility of synchronous transport between the large-sized and heavy material and the multiple AGVs.
S13. fusing AGV kinematic features and online sensor data.

Based on AGV kinematic features and sensor-collected information, dynamic behavior and real-time environmental perception are incorporated into the environmental description to form a high-dimensional scenario representation that reflects the motion state of the AGVs and the heavy material at the current moment.

The kinematic features of each AGV, such as a speed, an acceleration, and a steering angle, are combined with outputs from environmental sensors and a load sensor to generate real-time updated high-dimensional data:
1. vᵢ(t)∈ [symbol] ³ and aᵢ(t)∈ [symbol] ³ are defined to denote a speed vector and an acceleration vector of the i^{th} AGV at a moment t, respectively, and θᵢ(t) is defined to denote a steering angle.
2. Multi-sensor data are denoted as sᵢ(t), include ranging values from a lidar and load distribution values collected by a force sensor, are directly expressed in a matrix form as:

$${s}_{i} ( t ) = [ \begin{matrix}{r}_{i} ( t ) \\ {f}_{i} ( t )\end{matrix} ] , {r}_{i} ( t ) ∈ {ℝ}^{{d}_{τ}} , {f}_{i} ( t ) ∈ {ℝ}^{{d}_{f}} ;$$

where rᵢ(t) denotes an environmental distance data vector outputted by the lidar, fᵢ(t) denotes a load distribution data vector outputted by the force sensor, and dᵣ and d_{f} denote corresponding data dimensions.
3. A comprehensive state vector zᵢ(t) at a moment t is defined by combining the AGV kinematic parameters and sensor information:

$${z}_{i} ( t ) = {[ {v}_{i} ( t ) , {a}_{i} ( t ) , {θ}_{i} ( t ) , {s}_{i} ( t ) ]}^{T} .$$

zₘ(t) is defined to denote a comprehensive vector of real-time sensor data, position, and pose information corresponding to the heavy material.
4. The comprehensive state vectors of all AGVs and the heavy material are stacked and spliced to obtain a high-dimensional state matrix Z(t):

$$Z ( t ) = {[ z l ( t ) {z}_{2} ( t ) … {z}_{n} ( t ) {z}_{m} ( t ) ]}^{T} .$$

This matrix contains the kinematic information and sensor information of all the AGVs and the heavy material at the current moment.
S14. generating a high-dimensional environmental description vector.

Based on the geometric constraints, AGV-material kinematic features, and real-time sensor data, a high-dimensional environmental description vector of the overall co-transport scenario is outputted to provide a relatively favorable and comprehensive feature representation for the subsequent stage of strategy generation and control.

Specifically, by fusing the feasible region [symbol] (t) obtained in S12 and the state matrix Z(t) obtained in S13 under the global coordinate system, an environmental description function is defined, and a final vector suitable for learning or planning purposes is outputted.
1. An environmental description function E(t)=Ψ( [symbol] (t),Z(t)) is defined, with an output being a vector of dimension H:

$$E ( t ) = [ \begin{matrix}{e}_{1} ( t ) \\ {e}_{2} ( t ) \\ ⋮ \\ {e}_{H} ( t )\end{matrix} ] .$$

2. In the function Ψ(·,·), a weighted combination is performed on geometric attributes of the feasible region [symbol] (t) and the multi-source information of the AGVs and the heavy material in the state matrix Z(t) to form a mapping:

$${e}_{k} ( t ) = {ω}_{k 1} \cdot {𝒢}_{1} ( ℱ ( t ) ) + {ω}_{k 2} \cdot {𝒢}_{2} ( Z ( t ) ) + {δ}_{k} , k = 1 , 2 , … , H ;$$

where [symbol] ₁(·) denotes a geometric parameter extraction mapping, [symbol] ₂(·) denotes a kinematic and sensor fusion feature mapping, ωₖ₁, ωₖ₂ denote weighting coefficients at the k^{th} dimension, and δₖ denotes an offset associated with a specific dimensional feature.
3. The above H-dimensional outputs {e₁(t), e₂(t), . . . , e_{H}(t)} are stacked to obtain a high-dimensional environmental description vector E(t). This vector is capable of characterizing the co-transport state of the multiple heavy-duty AGVs and the large-sized and heavy material at a moment t, external environmental disturbances and geometric feasible region constraints.

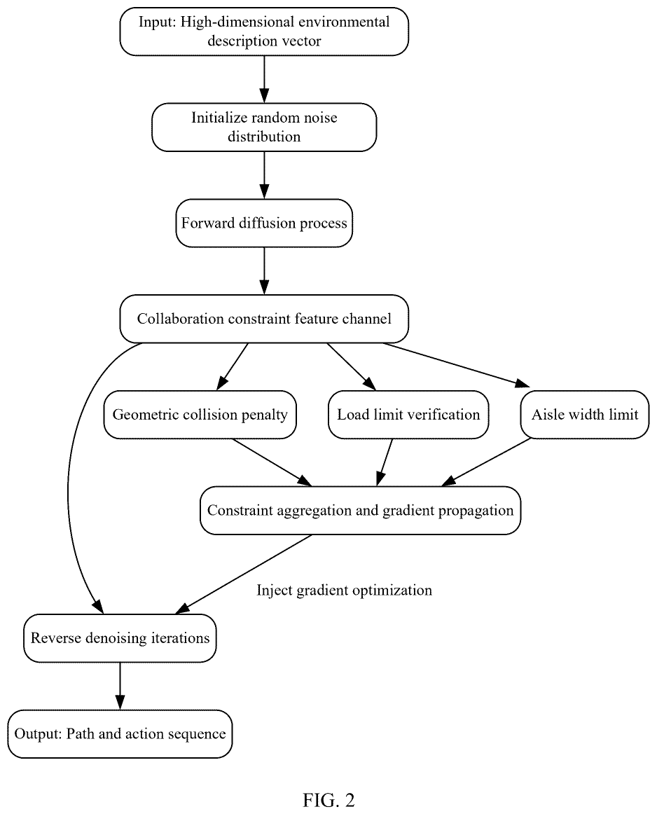

Thus, through the above step, the geometric constraints of the large-sized and heavy material in the multi-AGV collaboration scenario, the AGV kinematic features, and the sensor data are comprehensively expressed to form the high-dimensional environmental description vector.
S2. generating an initial multi-AGV co-transport solution according to an improved conditional diffusion model, as shown in FIG. 2.
S21. constructing a conditional input and an initial random distribution for co-transport.

This substep mainly aims to define the conditional input required by the improved conditional diffusion model and the initial random distribution, thereby providing a feasible search space for the diffusion process.

Specifically, the high-dimensional environmental description vector E(t) generated in S1 is employed as the conditional input of the model, and an initial random noise distribution is set in the path and action sequence space.
1. E(t)∈ [symbol] ^{H} is defined to denote a high-dimensional environmental description vector outputted at a moment t, and this vector comprehensively integrates the real-time feasible region of the multiple heavy-duty AGVs and the large-sized and heavy material, kinematic features, and sensor information.
2. A multi-AGV co-transport path and action sequence to be generated is defined as a high-dimensional variable X(t)∈ [symbol] ^{D}, where D denotes a total parameter dimension covering all required positions, speeds, poses, and execution actions in a discrete period or a series of steps.
3. The initial random noise distribution is defined to be pᵢₙᵢₜ (X), and a form of Gaussian probability distribution is employed as a starting point for the diffusion process:

$${X}^{0} ∼ {p}_{i n i t} ( X ) .$$

4. E(t) is used as a conditional channel through which conditional information is written into the improved diffusion model, to form a prior constraint for X⁰:

$${X}^{0} = {X}^{0} ( E ( t ) ) .$$

S22. designing a large-sized material collaboration constraint feature channel and establishing an improved diffusion equation.

To meet the specific requirements of large-sized material transport, the collaboration constraint channel is introduced into the denoising process of the conventional diffusion model in the present disclosure, such that the generated path and action sequence satisfies the material dimensions, load distribution, and factory aisle width requirements.

In the forward diffusion and reverse denoising processes, one large-sized material collaboration constraint feature channel is embedded, and by introducing a penalty function and a constraint function, random perturbations that do not meet the requirements for large-sized material co-transport are reduced.
1. A forward stochastic evolution equation of the standard diffusion process is defined as:

$${X}^{k} = \sqrt{{α}_{k}} {X}^{k - 1} + \sqrt{1 - {α}_{k}} {ϵ}_{k} , k = 1 , 2 , … , K ;$$

where 0<αₖ<1 denotes a retention weight for the state at a previous moment during the k^{th} iteration, ∈ₖ denotes a noise vector sampled from a standard Gaussian distribution, and K denotes the total number of forward diffusion steps.
2. In the reverse denoising stage, an improved collaboration constraint feature channel Γ_{large} (·) is introduced.

The reverse prediction equation is:

$${X}^{k - 1} = {f}_{θ} ( {X}^{k} , E ( t ) ) - λ {∇}_{{X}^{k}} {Ω}_{large} ( {X}^{k} , E ( t ) ) , k = K - 1 , … , 1 ;$$

where:
f_{θ}(·) denotes a function that performs prediction in the conventional diffusion model according to a current state and conditional input;
Ω_{large} (X^{k}, E(t)) denotes a penalty function for the large-sized material features, and reflects constraints of the material dimensions, the load distribution, and the factory aisle width on the path and action sequence; and
λ denotes a hyperparameter used to balance a basic denoising objective of the model and a suppression intensity of the large-sized material collaboration constraint feature channel.
3. In Ω_{large}, a plurality of penalty terms, including a geometric collision penalty, an overload penalty, and a factory aisle constraint penalty, are set for the large-sized and heavy material:

$${Ω}_{large} ( {X}^{k} , E ( t ) ) = {w}_{1} {Φ}_{collide} ( {X}^{k} , E ( t ) ) + {w}_{2} {Φ}_{overload} ( {X}^{k} , E ( t ) ) + {w}_{3} {Φ}_{narrow} ( {X}^{k} , E ( t ) ) ;$$

where w₁, w₂, w₃ denote weighting coefficients for the three penalty terms, respectively, and Φ_{collide}, Φ_{overload}, Φ_{narrow} correspond to the constraint functions for collision detection, load verification, and aisle width limit verification, respectively.
4. By performing backpropagation on a gradient of Ω_{large} in the reverse denoising process, random perturbations that do not meet the requirements for large-sized material co-transport are suppressed, such that the generated results are progressively guided toward a truly feasible solution that satisfies the material collaboration requirements.
S23. performing diffusion denoising iterations and outputting the initial transport path and action sequence.

After the large-sized material collaboration constraint feature channel is introduced, the denoising iterations of the improved diffusion model are completed to generate an initial multi-AGV collaboration solution that satisfies the constraints.

The forward diffusion and reverse denoising steps are performed sequentially. At the reverse denoising stage, the geometric penalty term and the load penalty term are integrated into the gradient calculation of the prediction function to obtain the final path and action sequence.
1. Forward diffusion is performed stepwise using the initial distribution X⁰ and the conditional input E(t) from S21 to obtain an intermediate state {X¹, X², . . . , X^{K}}.
2. Starting from X^{K}, reverse denoising is performed:

$${X}^{k - 1} = {f}_{θ} ( {X}^{k} , E ( t ) ) - λ {∇}_{{X}^{k}} {Ω}_{large} ( {X}^{k} , E ( t ) ) , k = K - 1 , … , 1.$$

3. After K iterations, the final transport path and action sequence

$${X}_{final}^{0}$$

is obtained, and then rearranged or decoded into path coordinates and action commands for the multiple AGVs at discrete time or key state moments:

$${P}_{path} , {A}_{control} = Υ ( {X}_{final}^{0} ) ;$$

where Pₚₐₜₕ denotes a reference trajectory point sequence of the respective AGVs throughout the transport process, A_{control} denotes a corresponding execution action sequence, and the function Y(·) is used to map the high-dimensional vector into an executable control command format.
S24. completing the output of the initial collaboration solution and preparing the subsequent dynamic control.

The preliminary solution corrected by the large-sized material collaboration constraints is outputted and integrated to form an input foundation for the subsequent high-dimensional differential geometric dynamic control.

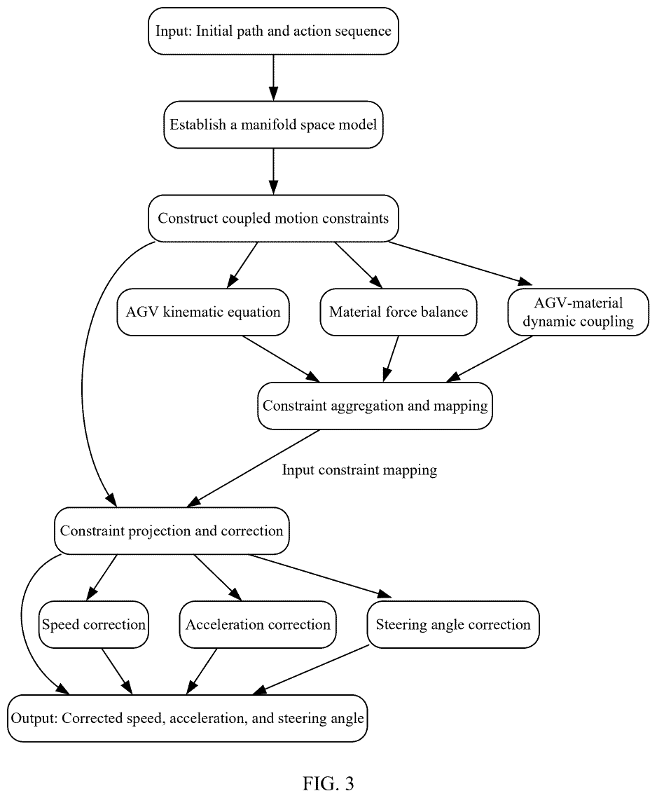

Specifically, the path and action sequence obtained in the previous step is structurally packaged and outputted to a control algorithm in the next stage.
1. The position, pose, speed, acceleration, and steering information of the multiple AGVs contained in Pₚₐₜₕ, A_{control} is indexed and recorded in a multi-AGV co-transport solution set:

$${𝒮}_{i n i t} = {\{ ( {p}_{1} , {a}_{1} ) , ( {p}_{2} , {a}_{2} ) , … , ( {p}_{n} , {a}_{n} ) \}}_{t ∈ [ 0 , T ]} ;$$

where pᵢ and aᵢ denote a path point sequence and an action command sequence of the i^{th} AGV in a transport cycle [0, T], respectively.
2. The preliminary multi-AGV collaboration solution [symbol] is outputted as an input for the subsequent high-dimensional differential geometric dynamic control, as well as for the subsequent dynamic environmental perception and replanning.
3. The preliminary solution, under the large-sized material collaboration constraints, already has basic feasibility and global consistency, thereby laying a foundation for the subsequent refined control and correction in the multi-AGV co-transport process.
S3. performing a multi-AGV synchronous motion correction using the high-dimensional differential geometric dynamic control, as shown in FIG. 3.
S31. establishing a manifold space model for the multiple AGVs and the heavy material.

This step mainly aims to express the coupled motion features of the multiple AGVs carrying the large-sized and heavy material in a high-dimensional space to form a manifold structure suitable for differential geometric control.

Specifically, the preliminary collaboration solution ( [symbol] ) outputted from S2 is regarded as a discretized approximate solution for the system state, the generalized coordinates of the system are defined on this basis, and a continuous description is provided for the overall feasible state of the multiple AGVs and the heavy material using a manifold theory.
1. The generalized coordinate vector of the system is defined as:

$$q ( t ) = {[ {q}_{1} ( t ) , {q}_{2} ( t ) , … , {q}_{n} ( t ) , {q}_{m} ( t ) ]}^{T} ;$$

where qᵢ(t)∈ [symbol] ^{r} denotes the pose (position and orientation) and additional dynamic parameters of the i^{th} AGV at a moment t, and qₘ(t)∈ [symbol] ^{s} denotes key states of the heavy material, such as a center pose and a force distribution.
2. The feasible domain where q(t) is located is defined as a manifold [symbol] ⊆ [symbol] ^{N}, where:

$$N = n \times r + s ;$$

n denotes the number of the AGVs, r denotes a state dimension of each AGV, and s denotes a state dimension of the heavy material.
3. Based on the path and action sequence in the preliminary solution [symbol] ᵢₙᵢₜ generated in S2, a preliminary discretized mapping for q(t) is constructed to serve as an input for a coupled dynamic correction in the next step:

$${q}_{init} ( t ) = \prod ( {𝒮}_{init} ) .$$

The function Π(·) is used to decode the discrete commands for the pose, speed, and acceleration of the multiple AGVs into a time-varying curve of the generalized coordinate vector.
S32. constructing a coupled motion constraint function and a introducing high-dimensional differential geometric constraint mapping.

Constraints are applied to the force and motion coupling relationships during the multi-AGV co-transport of the large-sized and heavy material, to ensure collaborative consistency among the AGVs and between the AGVs and the heavy material.

A constraint function describing the coupled motion is defined on the manifold M, and a dynamic mapping for differential geometric control is constructed to achieve corrections to the speed, the acceleration, and the steering angle.
1. In the manifold [symbol] a coupled motion constraint function is defined as:

$$f ( q ( t ) , \dot{q} ( t ) ) = 0 ;$$

this function reflects force balance, geometric collaboration, and motion consistency between the AGVs and the heavy material, and \dot{q}(t) denotes a time derivative of the generalized coordinates.
2. A kinematic equation of each AGV and a dynamic equation of the heavy material are unified as:

$${\dot{q}}_{i} ( t ) = {g}_{i} ( {q}_{i} ( t ) , {u}_{i} ( t ) ) , {\dot{q}}_{m} ( t ) = {g}_{m} ( {q}_{m} ( t ) , {u}_{m} ( t ) ) ;$$

where uᵢ(t) denotes a control input for the i^{th} AGV, and uₘ(t) denotes an external adjustment to a pose or mechanical state of the heavy material (such as synchronized lifting at a plurality of contact points, force distribution during turning, and the like).
3. All subsystem equations are merged in the manifold to obtain an overall evolution equation of the system:

$$\dot{q} ( t ) = G ( q ( t ) , u ( t ) ) ;$$

where:

$$u ( t ) = {[ {u}_{1} ( t ) , {u}_{2} ( t ) , … , {u}_{n} ( t ) , {u}_{m} ( t ) ]}^{T} ;$$

G(·,·) denotes an overall dynamic mapping for the coupling between the multiple AGVs and the heavy material.
4. A high-dimensional differential geometric constraint mapping h(q(t)) is defined, including a plurality of constraints on an AGV speed balance, a load distribution balance, and a stable material pose:

$$h ( q ( t ) ) = [ \begin{matrix}{h}_{1} ( q ( t ) ) \\ {h}_{2} ( q ( t ) ) \\ ⋮ \\ {h}_{p} ( q ( t ) )\end{matrix} ] ,$$

such that when h(q(t))=0 is satisfied in the manifold space, the coupled motion of the multiple AGVs and the heavy material remains in an ideal synchronous balanced state.
S33. performing the differential geometric dynamic correction and outputting the corrected speed, acceleration, and steering angle.

Based on a high-dimensional differential geometric method, a dynamic correction is performed on the preliminary solution, and motion correction values for each AGV when the constraint conditions are satisfied in the manifold space are solved for to ensure the motion consistency during the multi-AGV synchronous transport.

Specifically, a motion constraint projection in the manifold space is proposed and adopted to correct the speed, the acceleration, and the steering angle of each AGV, so as to output a correction solution that satisfies h(q(t))=0.

For the coupling constraint equation f(q, \dot{q})=0 and the differential geometric constraint h(q)=0 in S32, the generalized coordinates and speeds under the preliminary solution are corrected at the current moment t:

$${\dot{q}}_{corr} ( t ) = {\dot{q}}_{init} ( t ) - η {J}^{†} ∇ h ( {q}_{init} ( t ) ) ;$$

where \dot{q}ᵢₙᵢₜ(t) denotes a speed vector derived from the preliminary solution [symbol] ∇h(qᵢₙᵢₜ (t)) denotes a gradient of the constraint function; J^{†} denotes a generalized inverse matrix or projection matrix of a corresponding Jacobian matrix J; and η denotes a step size factor.

This is equivalent to performing a projection correction in a negative gradient direction of the constraint function in the manifold space, to cancel out components that violate synchronous coordination.

The acceleration and the steering angle of each AGV are corrected similarly:

$$\begin{matrix}{\ddot{q}}_{corr} ( t ) = {\ddot{q}}_{init} ( t ) - κ {J}^{†} ∇ h ( {\dot{q}}_{corr} ( t ) ) \\ {θ}_{i , corr} ( t ) = {θ}_{i , init} ( t ) - ζ ∇ h ( {q}_{corr} ( t ) )\end{matrix} ;$$

where κ and ζ denote adjustable coefficients used to distribute correction magnitudes for the acceleration and steering angle.

Through the above dynamic correction, the speed, acceleration, and steering angle correction values for the multiple AGVs, which satisfy the high-dimensional differential geometric coupling constraints, are obtained at a moment t, to further ensure the consistency of the multi-AGV motion.
S34. generating multi-AGV synchronous motion commands and outputting correction results.

The speed, acceleration, and steering angle control quantities obtained after the differential geometric dynamic correction are outputted as synchronous motion commands for actual execution by the multiple AGVs, thereby providing a more stable pose foundation for the next stage of dynamic environmental prediction and replanning.

Specifically, based on the corrected kinematic parameters, a synchronous motion command set for the multiple AGVs is uniformly constructed and packaged into a format executable by a actual controller.
1. Based on the correction results from S33, the synchronous motion command for each AGV at a moment t is defined:

$${u}_{i}^{corr} ( t ) = Ξ ( {\dot{q}}_{i , corr} ( t ) , {\ddot{q}}_{i , corr} ( t ) , {θ}_{i , corr} ( t ) ) ;$$

where Ξ(·) is used to convert the corrected speed, acceleration, steering angle, and the like into torque, rotational speed, or steering commands required for execution by an underlying control system of each AGV.
2. Correction command sets for all the AGVs throughout the entire transport cycle [0, T] are aggregated:

$${𝒰}^{corr} = {\{ {u}_{1}^{corr} ( t ) , {u}_{2}^{corr} ( t ) , … , {u}_{n}^{corr} ( t ) \}}_{t ∈ [ 0 , T ]} .$$

3. The corrected multi-AGV synchronous motion commands [symbol] ^{corr} and the updated system state q_{corr}(t) are outputted to ensure a motion consistency among the AGVs during the co-transport process, satisfy the force distribution and pose stability requirements of the large-sized and heavy material, and provide a stable pose foundation for the next stage of dynamic environmental prediction and replanning.
S4. performing the state prediction and disturbance anticipation for co-transport based on dynamic environmental perception.
S41. acquiring and fusing multi-source sensor information.

In the co-transport process of the large-sized and heavy material, dynamic data from the AGVs and environmental sensors are collected and fused in real time to provide a real-time environmental basis for the subsequent state prediction and disturbance anticipation.

Specifically, output data from various sensors, including a lidar, a camera, a force sensor, and an ultrasonic ranging sensor, are integrated to perform multi-dimensional fusion of disturbance source information (e.g., a temporary obstacle, road congestion) and material force loading information.
1. Multi-source sensor data collected by each AGV at a moment t are combined to form a matrix:

$${S}_{env} ( t ) = [ \begin{matrix}{s}_{1} ( t ) \\ {s}_{2} ( t ) \\ ⋮ \\ {s}_{n} ( t )\end{matrix} ] ;$$

where sᵢ(t) denotes an environmental information vector collected by the i^{th} AGV, including elements such as obstacles position, an aisle congestion level, and a mechanical load variation.
2. For time synchronization and network delays among the AGVs, a temporal alignment and weighted fusion method is employed, and the fusion result is denoted as:

$${S}_{fusion} ( t ) = Ω ( {S}_{env} ( t ) ) ;$$

Ω(·) is used to process temporal differences and data precision differences among different AGVs and output globally consistent environmental perception information.
S42. performing the state prediction and disturbance anticipation for co-transport.

Based on the real-time fused environmental information, a short-term prediction is performed on the future state of the AGVs and the heavy material in the co-transport process, potential disturbance sources are identified, and an impact of these disturbance sources on the multi-AGV motion is estimated.

Specifically, the synchronous motion commands corrected in S3 and the environmental perception data fused in S41 are combined, a rolling prediction of the recent state is performed through a dynamic model, and disturbance sources are predicted and calibrated.
1. A rolling prediction window ΔT is defined, and the system state at a future moment t+ΔT is predicted according to the dynamic equation \dot{q}(t)=G(q(t), u^{corr}(t)) of the AGVs and the heavy material:

$${q}_{pred} ( t + Δ T ) = {\prod }_{dyn} ( q ( t ) , {u}^{corr} ( t ) , {S}_{fusion} ( t ) ) ;$$

where Π_{dyn}(·) denotes a prediction function based on the coupled model of the multiple AGVs and the heavy material, and a corrected control input and a dynamic impact of environmental information are comprehensively considered.
2. Disturbance sources such as obstacle movement, aisle congestion, and load imbalance are predicted. A disturbance assessment function is defined as:

$${d}_{eval} ( t ) = {Φ}_{dist} ( {S}_{fusion} ( t ) , {q}_{pred} ( t + Δ T ) ) ;$$

Φ_{dist} (·) is used to quantify the risk of each disturbance source on the basis of the current environmental perception and future state prediction, and an impact indicator dₑᵥₐₗ (t) for the co-transport is outputted.
3. The predicted state and disturbance assessment results are fed back to a subsequent online replanning mechanism and dynamic control link, such that the system may promptly trigger the local path adjustment or control parameter correction upon detecting a potential risk.
S5. constructing an online feedback correction mechanism for multi-AGV collaboration and performing the local path adjustment.
S51. monitoring an AGV state deviation in real time and constructing an online feedback error function.

In this substep, the system continuously acquires the multi-AGV synchronous motion commands u^{corr}(t) outputted from S3 and the environmental perception data S_{fusion} (t) fused and generated in S4. A deviation between an actual state qᵢ(t) and an ideal reference state q_{i,ref}(t) of each AGV at a moment t is measured, and a feedback error function is defined as:

$${e}_{i} ( t ) = {‖ {q}_{i} ( t ) - {q}_{i , ref} ( t ) ‖}_{𝓌} ;$$

where ∥·∥_{w} denotes a norm operation in an appropriately weighted space (incorporating multi-dimensional information such as a speed, an acceleration, and a steering angle of each AGV).

When any eᵢ(t) exceeds a set threshold ∈ₜₕ, or a significant load imbalance is detected, or a speed limit is violated, the system triggers the online feedback correction process, such that the motion parameters of the AGVs are fine-tuned during operation to reduce an error to a tolerable range.
S52. dynamically triggering based on the disturbance prediction results and determining the anomaly level.

In this substep, the system receives the disturbance assessment dₑᵥₐₗ(t) and predicted state q_{pred}(t+ΔT) provided in S4, and comprehensively evaluates these results and real-time errors eᵢ(t). A grading function is defined as:

$$φ ( {e}_{i} ( t ) , {d}_{eval} ( t ) ) = \{ \begin{matrix}0 , & when {e}_{i} ( t ) \leq {∈}_{t h} and {d}_{eval} ( t ) is in a safe range , \\ 1 , & when {e}_{i} ( t ) > {∈}_{t h} or {d}_{eval} ( t ) reaches a warning level , \\ 2 , & \begin{matrix}when {d}_{eval} ( t ) reaches a critical level ( severe \\ obstruction or emergency )\end{matrix}\end{matrix} ;$$

when φ=0, the system only needs to maintain routine online monitoring;
when φ=1, the system triggers a moderate correction, such as a small-scale speed adjustment or a small-scale steering angle adjustment; and
when φ=2, it indicates presence of a severe disturbance or a potential hazard, a more mandatory response strategy, such as local path replanning or forced stopping, needs to be implemented immediately.
S53. applying constraints and performing optimization solving for local path replanning.

Once it is determined that the disturbance level reaches a degree requiring a path adjustment (φ=1 or 2), a local path replanning algorithm is initiated in this substep to ensure the AGVs maintain the established global objective while preventing or mitigating the impact of the current disturbance as much as possible. An optimization objective function for the local path search is proposed and defined as:

$${J}_{local} ( x ) = {\int }_{0}^{Δ s} ( α {Ψ}_{o b s} ( x ( s ) ) + β {Ψ}_{deviate} ( x ( s ) ) + γ {Ψ}_{energy} ( x ( s ) ) ) ds ;$$

where x(s) denotes a spatial-temporal trajectory of the multiple AGVs within a local range [0, Δs]; Ψ_{obs} is used to measure an obstacle avoidance cost; Ψ_{deviate} is used to measure a degree of deviation from the global reference path; Ψ_{energy} denotes an energy consumption cost or mechanical load cost; and α, β, γ denote weighting coefficients. By executing an optimization algorithm minimizing J_{local} in the local feasible region (such as a Rapidly-Exploring Random Tree algorithm, an improved A* algorithm, or a nonlinear optimizer), an optimal local running route for the AGVs under the current disturbance conditions is obtained.
S54. outputting re-corrected motion commands and forming an online feedback loop.

Finally, this substep aims to perform a differential geometric dynamic correction on the local replanning results (with reference to the coupling constraints in Step S3) to obtain corrected speed, acceleration, and steering angle control quantities

$$\{ {u}_{1}^{n e w} ( t ) , … , {u}_{n}^{n e w} ( t ) \} .$$

Simultaneously, a new reference state

$${q}_{i , ref}^{n e w} ( t )$$

is sent to an underlying controller of each AGV:

$${u}_{i}^{n e w} ( t ) = Θ ( {x}_{i}^{*} ( t ) , {\dot{x}}_{i}^{*} ( t ) , {\ddot{x}}_{i}^{*} ( t ) ) ;$$

where

$${x}_{i}^{*} ( t )$$

denotes an optimal trajectory discretized point of an optimized local path, and Θ(·) denotes a control signal mapping function used to convert pose and kinematic information into AGV execution commands.

Through this command update, the system forms a closed loop together with the above online feedback correction mechanism: When a deviation or disturbance is detected again, the cyclic process from S51 to S54 continues, thereby achieving a timely response and a flexible adjustment to various disturbances on the entire transport route.
S6. performing a high-precision transport action according to a multi-heavy-duty-AGV synchronous control strategy.
S61. establishing a coupled dynamic equation for multi-heavy-duty-AGV synchronous control.

In this substep, to uniformly describe the coupled dynamic relationship between the multiple AGVs and the heavy material, an overall dynamic equation of the system is defined.
q(t) is defined to denote the generalized coordinates of the system composed of the multiple AGVs and the heavy material (with reference to the manifold definition in S3), and then the dynamic equation with coupling terms may be expressed as:

$$M ( q ( t ) ) \ddot{q} ( t ) + C ( q ( t ) , \dot{q} ( t ) ) \dot{q} ( t ) + G ( q ( t ) ) = τ ( t ) ;$$

where M(·) denotes a mass-inertia matrix, C(·) denotes a Coriolis and centrifugal force term, G(·) denotes a vector of gravity and other pose-dependent generalized forces; τ(t) denotes a total control force/torque vector (including a driving torque, a braking torque, a steering torque, and the like) outputted by the multiple AGVs, respectively. Through this equation, an overall description is provided for the coupled motion of the AGVs carrying the large-sized and heavy material, thereby laying a foundation for the design of a multi-heavy-duty-AGV synchronous control law in the next step.
S62. designing the multi-heavy-duty-AGV synchronous control law.

This substep aims to ensure, based on the above coupled dynamic equation, consistent force, speed, and pose adjustments applied by each AGV to the heavy material by using a synchronous control strategy. q_{ref}(t) is defined to denote an expected system trajectory (in combination with the local path adjustment and online feedback results from S5), and q (t) is defined to denote an actual system state. A synchronization error is defined as:

$$e ( t ) = {q}_{ref} ( t ) - q ( t ) .$$

To achieve fast and stable error convergence, the multi-heavy-duty-AGV synchronous control law is proposed and designed:

$$τ ( t ) = {K}_{p} e ( t ) + {K}_{d} \dot{e} ( t ) + C ( q , \dot{q} ) \dot{q} ( t ) + G ( q ( t ) ) ;$$

where Kₚ and K_{d} denote positive definite gain matrices, and correspond to feedback terms for a position/pose error and a speed error, respectively; and C(·)\dot{q} and G(·) are used to compensate for the coupling, gravity, and other terms in the dynamics.

Through the above control law, the AGVs, under the action of the combined force/torque, tend to follow the expected trajectory to achieve synchronous carrying and precise pose maintenance.
S63. allocating AGV outputs in real time and maintaining a force balance among the multi heavy-duty AGVs.

In this substep, to prevent extreme load distribution or motion inconsistency among the AGVs, a total control force/torque τ(t) is decomposed in real time to obtain an individual output τᵢ(t) for each AGV:

$$τ ( t ) = {\sum }_{i = 1}^{n} {τ}_{i} ( t ) , {τ}_{i} ( t ) = {α}_{i} τ ( t )$$

where αᵢ denotes a current load distribution coefficient for the i^{th} AGV, and satisfies

$${\sum }_{i = 1}^{n} {α}_{i} = 1 .$$

The coefficient may be dynamically adjusted according to real-time sensor load measurements, AGV dynamic performance, steering requirements, and the like, such that an actually outputted total resultant force remains still consistent with τ(t) calculated by the synchronous control law. Thereby, a force balance among the multiple heavy-duty AGVs is maintained, and single-AGV overload or drag imbalance situation is prevented.
S64. transmitting high-precision synchronous motion commands and performing the transport action.

In this substep, high-precision motion commands suitable for direct execution are formed by mapping the results of the above multi-heavy-duty-AGV control law and AGV output allocation to an underlying control system.
ωᵢ(t) is defined to denote an actual execution command vector for the i^{th} AGV (including a driving motor speed and a steering wheel angle), then:

$${ω}_{i} ( t ) = Ψ ( {τ}_{i} ( t ) , {\dot{q}}_{i} ( t ) ) ;$$

where Ψ(·) denotes a transformation function converting a target force/torque into actual motor speed, steering angle, and possible braking commands.

Finally, each AGV performs the transport action according to ωᵢ(t). Constrained by the multi-heavy-duty-AGV synchronous control strategy, the AGVs continuously maintain precise carrying of the large-sized and heavy material and stable motion, thereby achieving the high-precision overall transport objective.

The method of the embodiments has at least the following advantages compared with the related art:

In this embodiment, based on the methods for constructing a global coordinate system and an entity set, geometric constraint relationships and dynamic state representations between the multiple AGVs and the large-sized and heavy material are defined to form a unified high-dimensional environmental description vector. A real-time fusion strategy for multi-source sensor data (such as data from a lidar and a force sensor) is introduced, and a comprehensive state matrix is generated in combination with the AGV kinematic features. Compared with the related art where environmental modeling in multi-AGV co-transport is usually limited to geometric constraints or simple kinematic features, and thus lacks comprehensive integration of dynamic sensing information, the method of this embodiment achieves construction of a real-time updated high-dimensional environmental description vector by using the global coordinate system, fusion of multi-source sensor data (such as data from a lidar and a force sensor), and AGV kinematic features. This vector is capable of dynamically reflecting the co-transport state of the multiple AGVs and the large-sized and heavy material, and ensuring the comprehensiveness and real-timeness of the high-dimensional environmental description.

In this embodiment, an improved conditional diffusion model is employed, a collaboration constraint feature channel is introduced, and the diffusion process is dynamically adjusted through penalty functions (such as geometric collision, overload, and aisle width limit). A constraint-optimized diffusion denoising mechanism is defined, and random perturbations are progressively guided to a path and action sequence that meets the co-transport requirements of the large-sized and heavy material. Compared with the related art where generation of the path and action sequence usually relies on a static optimization or planning-based method, and it is difficult to cope with complex collaboration constraints, especially in a large-sized material transport scenario, the method of the present disclosure enhances the feasibility and collaboration of generated results by proposing an improved conditional diffusion model, introducing a collaboration constraint feature channel, and embedding geometric constraints, load limits, and aisle width limits.

In the multi-AGV and material transport scenario, this embodiment provides a continuous description for the force and motion states of the multi-AGV collaboration by constructing a generalized coordinate vector according to a manifold theory. Coupled motion constraints and dynamic mappings are employed to optimize the speed, the acceleration, and the steering angle of each AGV to ensure dynamic consistency in the multi-AGV synchronous motion. Compared with the related art where multi-AGV collaborative control usually employs a simple feedback control strategy, making it difficult to comprehensively characterize the complex force coupling relationship among the multiple AGVs, the method of this embodiment, by utilizing the manifold theory to provide continuous motion states of the multiple AGVs and the heavy material, in combination with coupling constraints and dynamic mappings, achieves a precise correction to the speed, the acceleration, and the steering angle, thereby ensuring dynamic consistency in the multi-AGV synchronous motion.

In this embodiment, multi-source sensor data are integrated, and globally consistent real-time environmental information is acquired through temporal alignment and weighted fusion. A disturbance assessment function is incorporated into a rolling prediction model to quantify disturbance sources such as obstacles and load distribution imbalance, and corresponding risk indicators are outputted. Compared with the related art where environmental perception is mostly limited to single-sensor data, and the capabilities for disturbance source identification and state prediction are limited, the method of this embodiment enables fusion of multi-source sensor data, and generation of globally consistent dynamic environmental information through temporal alignment and weighted fusion, and achieves accurate quantification and prediction of disturbance sources such as obstacles and load imbalance in combination with the rolling prediction model and disturbance assessment function.

In this embodiment, a feedback error function is defined by monitoring an error between an actual AGV state and an ideal state in real time, and multi-level disturbance responses are dynamically triggered. A local path optimization algorithm is introduced to perform local path replanning based on spatial-temporal constraints while ensuring consistency with the global objective. Compared with the related art where path adjustments are mostly performed offline, resulting in a slow response speed and a difficulty in dynamically adapting to environmental changes, the method of this embodiment, through real-time error monitoring and a hierarchical feedback mechanism, enables dynamic triggering of a local path adjustment according to the disturbance level, and achieves rapid generation of a locally optimal path using an optimization algorithm, thereby ensuring high flexibility and robustness of the system.

This embodiment proposes a coupled dynamic model for multi-AGV collaboration to dynamically couple the motion between the AGVs with the force of the large-sized and heavy material. A synchronous control law and an output allocation mechanism are designed to maintain synchrony among the AGVs and a dynamic balance in load distribution during the movement of the AGVs. Compared with the related art where force distribution among the multiple AGVs mostly relies on empirical rules or equal distribution strategies, making it difficult to cope with the complex dynamic force scenario, the method of this embodiment, by designing the multi-heavy-duty-AGV synchronous control law based on a coupled dynamic equation, achieves a dynamic balance in load distribution through real-time allocation of AGV outputs, thereby eliminating a single-AGV overload or drag imbalance problem.

This embodiment considers the specific optimization requirements for transporting the large-sized and heavy material. Compared with the related art which fails to adequately consider special constraints such as a dimensional boundary of the large-sized and heavy material, a load distribution, and a factory aisle width, the method of this embodiment incorporates in both the diffusion model and the differential geometric control a plurality of constraints, particularly a geometric collision penalty, overload verification, and factory aisle width limit verification, thereby specifically optimizing path generation and synchronous control.

The method of the present disclosure further has the following commercial values:

Wide applicability and great market demand:

The method may be widely applied in various scenarios such as intelligent manufacturing, logistics and warehousing, and port handling, and particularly in scenarios requiring co-transport of the large-sized and heavy material, such as automotive manufacturing, aerospace assembly, and semiconductor equipment transport.

With the ongoing advancement of Industry 4.0, the market demand for multi-AGV co-transport and automated logistics systems continues to grow. The method of the present disclosure enhances the capabilities of conventional logistics and manufacturing industries through intelligent and precise collaborative control.

### Significant Reduction in Operational Costs:

Through the efficient path planning, dynamic control, and real-time feedback, this technology reduces energy waste and misoperation risks in multi-AGV co-transport.

This technology improves an equipment utilization rate, reduces reliance on manual intervention, and greatly lowers labor and time costs for enterprises in warehousing and handling processes.

### Enhanced Safety and Reliability:

The multi-source data fusion and dynamic disturbance prediction are introduced, and real-time perception of environmental changes and proactive avoidance of potential risks are achieved, such that the safety of the transport process is improved.

The specific optimization for the large-sized and heavy material reduces the risk of accidents such as dropping or collision during material transport, such that the overall reliability of the transport system is enhanced.

Meeting complex scenario requirements and improving system flexibility:

Through the collaboration constraint feature channel and high-dimensional differential geometric dynamic control, the method supports refined operations of multi-AGV co-transport in complex scenarios, and particularly meets the high-precision transport requirements for the large-sized and heavy material.

The method enables dynamic adjustment of the path and control strategy, and achieves quick adaptation to dynamic needs such as production line changes and environmental changes, thereby enhancing the flexibility of logistics and transport systems.

Although the present disclosure has been described in detail above through general descriptions and specific embodiments, some modifications or improvements may be made based on the present disclosure, and the modifications or improvements are apparent to those skilled in the art. Therefore, such modifications or improvements made without departing from the principle of the present disclosure fall within the scope claimed by the present disclosure.

What is claimed is:

1. A method for collaborative control of multiple AGVs co-transporting a heavy material, comprising:
1) inputting a high-dimensional environmental description vector into an improved conditional diffusion model as a model condition, to obtain a preliminary solution comprising an initial path and action sequence of the multiple AGVs to collaboratively perform a transport task, wherein the high-dimensional environmental description vector integrates kinematic feature information of the multiple AGVs to perform the transport task, real-time feasible region information of the multiple AGVs and a heavy material that the multiple AGVs co-transport, as well as real-time environmental information and real-time load information of the multiple AGVs collected by sensors; wherein
the improved conditional diffusion model is constructed by adding a geometric collision penalty term, an overload penalty term, and a factory aisle constraint penalty term for the heavy material in a reverse prediction equation in a reverse denoising phase of a conventional conditional diffusion model;
2) providing an overall continuous description for the initial path and action sequence using a manifold theory, correcting the obtained overall continuous description result to obtain correction values for a speed, an acceleration, and a steering angle of one or more AGVs when constraint conditions are satisfied in a manifold space, and determining motion commands for the one or more AGVs according to the correction values to achieve collaborative motion control on the multiple AGVs; wherein
the constraint conditions refer to the satisfaction of a defined coupling motion constraint function for a force balance between the multiple AGVs and the heavy material, and the satisfaction of a defined high-dimensional differential geometric constraint mapping comprising a plurality of constraints on an AGV speed balance, a load distribution balance, and a stable material pose; and
3) in the collaborative motion control on the multiple AGVs, performing a short-term prediction on a future state according to real-time detection results from environmental sensors, and assessing a safety risk during operation of the multiple AGVs according to the short-term prediction result, implementing different adjustment strategies according to different safety risk assessment results to ensure the operational safety of the multiple AGVs; wherein
a multi-heavy-duty-AGV synchronous control law is designed based on a coupled dynamic equation, and a dynamic balance of load distribution is achieved through real-time allocation of AGV outputs.

2. The method for collaborative control of multiple AGVs co-transporting a heavy material according to claim 1, wherein the real-time feasible region information comprises a load limit, material dimensions, and an overall feasible region of the multiple AGVs and the heavy material;
and when a load of the multiple AGVs and the material dimensions are within the feasible region, co-transporting the heavy material is implementable under current geometric and load constraints.

3. The method for collaborative control of multiple AGVs co-transporting a heavy material according to claim 1, wherein the reverse prediction equation in the reverse denoising phase of the improved conditional diffusion model is expressed as:
$${X}^{k - 1} = {f}_{θ} ( {X}^{k} , E ( t ) ) - λ {∇}_{{X}^{k}} {Ω}_{large} ( {X}^{k} , E ( t ) ) , k = K - 1 , … , 1 ; and$$
$${Ω}_{large} ( {X}^{k} , E ( t ) ) = {w}_{1} {Φ}_{collide} ( {X}^{k} , E ( t ) ) + {w}_{2} {Φ}_{overload} ( {X}^{k} , E ( t ) ) + {w}_{3} {Φ}_{narrow} ( {X}^{k} , E ( t ) ) ;$$
wherein f_{θ}(·) denotes a function in the conventional diffusion model for prediction according to a current state and conditional input, Ω_{large} (X^{k}, E(t)) denotes a penalty function for large-sized material features, λ denotes a hyperparameter for balancing a basic denoising objective of the model and a suppression intensity of a large-sized material collaboration constraint feature channel, w₁, w₂, w₃ denote weight coefficients for the three penalty terms, respectively, and Φ_{collide}, Φ_{overload}, Φ_{narrow} correspond to constraint functions for collision detection, load verification, and aisle width limit verification, respectively.

4. The method for collaborative control of multiple AGVs co-transporting a heavy material according to claim 1, wherein the correcting the obtained overall continuous description result comprises: defining a constraint function for the coupled motion on a manifold, constructing a high-dimensional differential geometric constraint mapping for differential geometric control, dynamically correcting the preliminary solution according to a high-dimensional differential geometric method, and solving for motion correction values for one or more AGVs when the constraint conditions are satisfied in the manifold space.

5. The method for collaborative control of multiple AGVs co-transporting a heavy material according to claim 4, wherein the dynamically correcting the preliminary solution according to a high-dimensional differential geometric method is as follows: performing a projection correction in a negative gradient direction of the constraint function in the manifold space, to cancel out components that violate synchronous coordination.

6. The method for collaborative control of multiple AGVs co-transporting a heavy material according to claim 5, wherein the constraint function for the coupled motion is expressed as: f(q(t), \dot{q}(t))=0, wherein q(t) denotes a time-varying curve of a generalized coordinate vector providing the overall continuous description for the initial path and action sequence, and \dot{q}(t) denotes a time derivative of the generalized coordinates;
the high-dimensional differential geometric constraint mapping h(q(t)) is expressed as:
$$h ( q ( t ) ) = [ \begin{matrix}{h}_{1} ( q ( t ) ) \\ {h}_{2} ( q ( t ) ) \\ ⋮ \\ {h}_{p} ( q ( t ) )\end{matrix} ] ,$$
wherein hᵢ(q(t)) denotes a plurality of constraints on an AGV speed balance, a load distribution balance, and a stable material pose; and when h(q(t))=0 is satisfied in the manifold space, the coupled motion of the multiple AGVs and the heavy material is in an ideal synchronous balanced state; and
a formula for dynamically correcting the preliminary solution according to the high-dimensional differential geometric method is expressed as:
$${\dot{q}}_{corr} ( t ) = {\dot{q}}_{i n i t} ( t ) - η {J}^{†} ∇ h ( {q}_{i n i t} ( t ) ) ;$$
$${\ddot{q}}_{c o r r} ( t ) = {\ddot{q}}_{i n i t} ( t ) - κ {J}^{†} ∇ h ( {\dot{q}}_{corr} ( t ) )$$
$${θ}_{i , corr} ( t ) = {θ}_{i , init} ( t ) - ζ ∇ h ( {q}_{corr} ( t ) ) ;$$
wherein \dot{q}_{corr}(t), \ddot{q}_{corr}(t), and θ_{i,corr}(t) denotes a corrected speed, a corrected acceleration, and a corrected steering angle for one or more AGVs, respectively, \dot{q}ᵢₙᵢₜ (t) denotes a speed vector derived from the preliminary solution, and ∇h(qᵢₙᵢₜ (t)) denotes a gradient of the constraint function; and J^{†} denotes a generalized inverse matrix or projection matrix of a corresponding Jacobian matrix J, η denotes a step size factor, and κ and ζ denote adjustable coefficients used to allocate correction magnitudes for the acceleration and the steering angle.

7. The method for collaborative control of multiple AGVs co-transporting a heavy material according to claim 1, wherein the environmental sensors are multi-source environmental sensors, and the real-time detection results from environmental sensors are globally consistent dynamic environmental information generated by fusing the results of the multi-source environmental sensors through the temporal alignment and weighted fusion.

8. The method for collaborative control of multiple AGVs co-transporting a heavy material according to claim 7, wherein the performing a short-term prediction on a future state comprises:
predicting disturbance sources such as obstacle movement, aisle congestion, and load imbalance in combination with the dynamic environmental information and the motion commands obtained; and
measuring a deviation between an actual state and an ideal reference state of one or more AGVs at a same moment in combination with the dynamic environmental information and the motion commands obtained.

9. The method for collaborative control of multiple AGVs co-transporting a heavy material according to claim 8, wherein the assessing a safety risk during operation of the multiple AGVs according to the short-term prediction result comprises:
in response to determining that the prediction result of the disturbance sources falls within a safe range and a measured result of the deviation does not exceed a set threshold, determining a safety risk level as 0;
in response to determining that the prediction result of the disturbance sources reaches a warning level or the measured result of the deviation exceeds the set threshold, determining the safety risk level as 1; and
in response to determining that the prediction result of the disturbance sources reaches a critical level of severe obstruction or an emergency, determining the safety risk level as 2.

10. The method for collaborative control of multiple AGVs co-transporting a heavy material according to claim 9, wherein the implementing different adjustment strategies according to different safety risk assessment results comprises:
in response to determining that the safety risk level is 0, requiring only routine online monitoring;
in response to determining that the safety risk level is 1, triggering a moderate correction of a speed adjustment or a steering angle adjustment; and
in response to determining that the safety risk level is 2, implementing immediately a more mandatory response strategy of local path replanning or forced stopping.
